(19) United States
(12) Patent Application Publication
(10) Pub. No.: US 2022/0230610 A1
(43) Pub. Date: Jul. 21, 2022

(54) MUSICAL INSTRUMENT PICKUP

(71) Applicant: Leonard Theriault, Enderby (CA)

(72) Inventor: Leonard Theriault, Enderby (CA)

(21) Appl. No.: 17/153,776

(22) Filed: Jan. 20, 2021

(51) Int. Cl. G10H 3/18; H01F 27/28; H01F 27/24

(52) U.S. Cl. CPC G10H 3/181; G10H 2220/461; H01F 27/24; H01F 27/2823

(57) ABSTRACT

A method, apparatus and kit for forming a pickup for a musical instrument comprises a ferromagnetic core having an electrical winding wound therearound, the electrical winding having an output wire operable to output a signal for receipt by an amplifier representing sound vibrations produced by the musical instrument, an activation magnet, and a flexible mount wherein one of the ferromagnetic core and the activation magnet are rigidly secured to the musical instrument and wherein the flexible mount is located the ferromagnetic core and activation magnet so as to permit a degree of movement by the other of the ferromagnetic core and activation magnet relative to the musical instrument under vibration thereof.

### BACKGROUND

### 1. Technical Field

This disclosure relates generally to musical instruments and in particular to method and apparatus for picking up for amplification musical vibrations in an instrument.

### 2. Description of Related Art

Musical instruments commonly produce the desired sounds by vibration of a string or other portion of the instrument at the desired frequency. Such instruments have existed for centuries. However, in recent times it is frequently desirable to amplify the sounds produced by an instrument for a larger audience or for playing to remote audience.

This need to amplify music from an instrument is particularly problematic for acoustic instruments, such as acoustic guitars and the like. Previous attempts to amply acoustic guitars have ben unsatisfactory. In particular, attempts have been made to locate conventional string pickups in the body of acoustic guitars, to pick up vibrations of the strings directly. Such designs however lose the unique sonic characteristics of the acoustic guitar body itself by rendering those portions of the guitar other than the strings irrelevant.

Furthermore, other attempts have been made to provide a microphone in the guitar to pick up the direct acoustic sounds produced by the guitar. It will be appreciated, however that such microphones are quite sensitive to the placement location and therefore may be difficult for users to find the best location for their tastes.

Furthermore, attempts have been made to utilize transducers, such as piezoelectric transducers which are commonly located under the saddle or on the soundboard of the guitar to sense movement or compression of the saddle or other elements of the instrument. However, such transducers are known to have difficulty producing accurate sounds when the instrument is amplified loudly or prone to feedback.

### SUMMARY OF THE DISCLOSURE

According to a first embodiment, there is disclosed a pickup for a musical instrument comprising a ferromagnetic core having an electrical winding wound therearound, the electrical winding having an output wire operable to output a signal for receipt by an amplifier representing sound vibrations produced by the musical instrument, an activation magnet, and a flexible mount wherein one of the ferromagnetic core and the activation magnet are rigidly secured to the musical instrument and wherein the flexible mount is located the ferromagnetic core and activation magnet so as to permit a degree of movement by the other of the ferromagnetic core and activation magnet relative to the musical instrument under vibration thereof.

One of the ferromagnetic core and the activation magnet may be secured within a cavity in the musical instrument. The flexible mount may be permanently secured to the musical instrument.

The ferromagnetic core may be rigidly connected to the musical instrument and wherein the activation magnet is located within the flexible mount. The activation magnet may be rigidly connected to the musical instrument and wherein the ferromagnetic core is located within the flexible mount.

The flexible mount may comprise a sheet of pliable material magnetically clamped between the ferromagnetic core and the activation magnet. The sheet of pliable material may be selected from the group consisting of silicone, foam and rubber.

The ferromagnetic core may include a permanent magnet attached thereto. The ferromagnetic core may comprise an iron core having the electrical winding therearound defining an axis therethrough. The pickup may further comprise a permanent magnet secured to the iron core perpendicularly to the axis. The iron core may have a substantially rectangular cross section.

The pickup may further comprise a body selectably coupleable to the musical instrument having the ferromagnetic core connected thereto. The flexible mount may include a connector operable to selectably couple and decouple the flexible mount to the musical instrument. The connector may comprise a clamp.

The flexible mount may include a pocket adapted to receive the activation magnet. The pocket is sized to compressibly receive one of the ferromagnetic core and the activation magnet therein. The output wire may extend down a neck of the guitar to a plug in a body of the guitar. The output wire may be located within a truss rod extending through the neck.

According to a further embodiment, there is disclosed a method for amplifying a musical instrument comprising providing a ferromagnetic core having an electrical winding wound therearound, the electrical winding having an output wire operable to output a signal for receipt by an amplifier representing sound vibrations produced by the musical instrument, locating a flexible mount between the ferromagnetic core and an activation magnet, rigidly securing one of the ferromagnetic core and the activation magnet to the musical instrument and magnetically coupling the ferromagnetic core and the activation magnet together with the flexible mount therebetween as to have a degree of movement relative to each other under vibration from the musical instrument.

According to a further embodiment, there is disclosed a kit for amplifying a musical instrument comprising a ferromagnetic core having an electrical winding wound therearound, the electrical winding having an output wire operable to output a signal for receipt by an amplifier representing sound vibrations produced by the musical instrument, an activation magnet and a flexible mount securable between the ferromagnetic core and the activation magnet wherein one of the ferromagnetic core and the activation magnet are rigidly securable to the musical instrument and wherein the other of the ferromagnetic core and activation magnet is magnetically secured thereto with the flexible mount therebetween so as to have a degree of movement relative to the musical instrument under vibration thereof.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of the neck of an acoustic guitar having a pickup according to a first embodiment of the present disclosure thereon.

FIG. 2 is a detailed rear perspective view of the pickup of FIG. 1 being applied to the head of an acoustic guitar.

FIG. 3 is a cross sectional view of the pickup of FIG. 2 as taken along the line 3-3.

FIG. 4 is a perspective view of the flexible mount of the pickup of FIG. 2 being applied to the head of a guitar.

FIG. 5 is a cross sectional view of the neck of an acoustic guitar with a wire from the electrical winding extending down the truss rod thereof.

FIG. 6 is an exploded perspective view of a pickup according to a further embodiment.

FIG. 7 is an exploded perspective view of a pickup according to a further embodiment.

### DETAILED DESCRIPTION

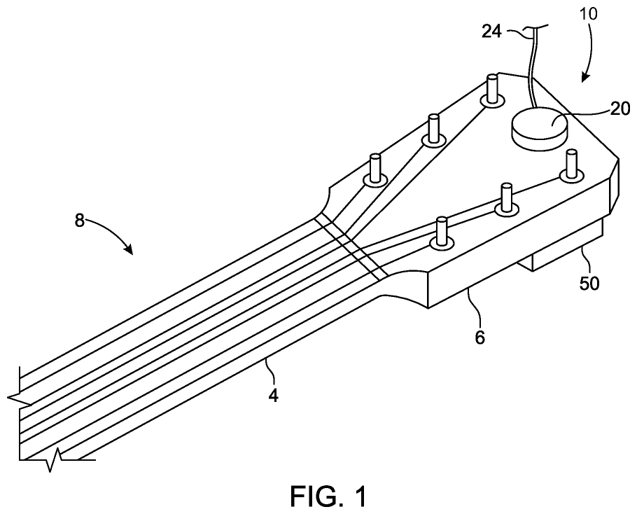

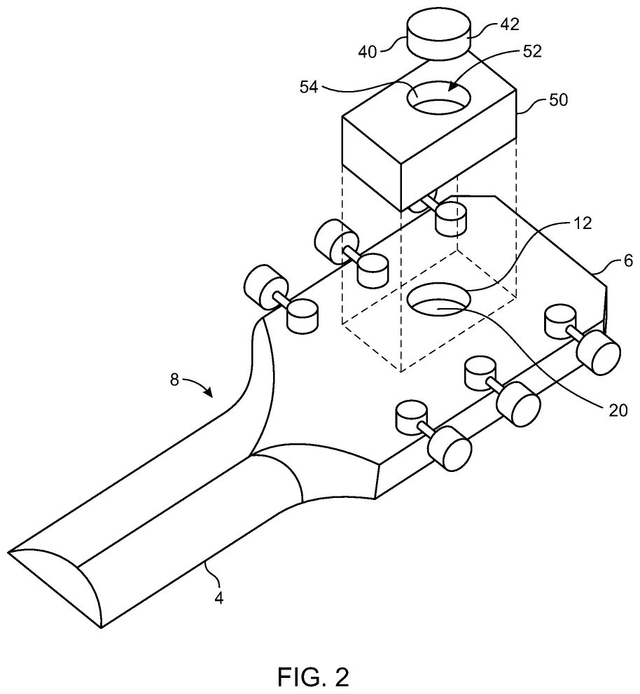

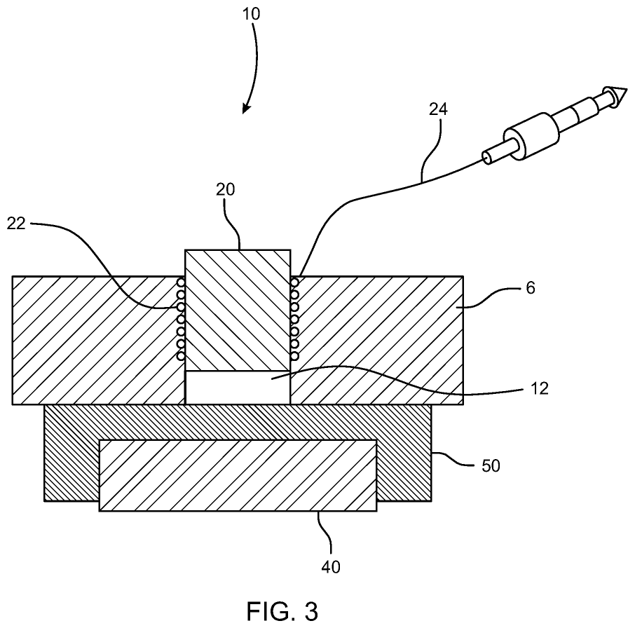

Aspects of the present disclosure are now described with reference to exemplary apparatuses, methods and systems. Referring to FIG. 1, an exemplary apparatus for sensing mechanical vibrations in a musical instrument according to a first embodiment is shown generally at 10 secured to a guitar 8. It will be appreciated that although the present disclosure relates to the application of the present method and apparatus to a guitar that such methods, kit and apparatus may also be applied to another musical instrument to provide amplification therefore. Examples of such musical instruments may include, but are not limited to, stringed instruments including Chellos, ukuleles and banjos, pianos, violins, stand up base or a mandolin although it will be appreciated that it may be useful with other instruments as well. As illustrated in FIGS. 1 and 2, the apparatus comprises a ferromagnetic core 20 having at least one electrical winding (as shown in FIG. 3) therearound and an activating magnet 40. One of the ferromagnetic core 20 or activating magnet 40 is rigidly connected to the musical instrument and the other of the ferromagnetic core 20 and activating magnet 40 is connected to a flexible mount 50 which is connected to the instrument. The flexible mount 50 permits the ferromagnetic core or magnet located therein to move independently of the musical instrument such that a relative movement is created between the ferromagnetic core and the magnet by the vibrations of the musical instrument. This relative movement between the ferromagnetic core and the magnet creates a fluctuation current in the winding which can be received at an amplifier to be converted into sound according to known means.

As illustrated in FIGS. 1 through 3, the ferromagnetic core 20 is received within a void 12 in the head 6 of the guitar 8. The void 12 may be formed as a bore extending through the head 6 as illustrated in FIGS. 1 through 3 or may optionally be formed as a blind bore extending only into one of the front or rear surface of the head. The ferromagnetic core 20 is formed of any suitable ferromagnetic material, such as, by way of non-limiting example, iron or the like as are commonly known. As illustrated, the ferromagnetic core 20 is formed in a cylindrical shape, although it will be appreciated that other shapes may also be utilized. The ferromagnetic core 20 may have a length selected to be contained within the void 12.

As illustrated in FIG. 3, the ferromagnetic core 20 includes at least one electrical winding 22 therearound as are commonly known. The electrical winding 22 may be of any conventional type and formed of any conventional materials as are known in the art of musical amplification. The electrical winding 22 includes a lead wire 24 extending away therefrom which may be electrically connected to an amplifier or the like to receive frequencies picked up by the electrical winding in use. Optionally, the ferromagnetic core 20 and electrical windings 22 may be formed to have a diameter to be snugly fit within the void 12 so as to enable securing therein.

The activating magnet 40 may be of any suitable permanent type including without limitation, ferromagnetic or rare earth and may be of any suitable shape and size. The activating magnet 40 as illustrated is received within the flexible mount body 50 which is secured to the instrument proximate to the void 12 containing the ferromagnetic core 20. As illustrated in FIG. 2, the flexible mount 50 is secured to the rear of the head 6 of the guitar so as to cover the void 12 although other locations may be utilized as well.

Turning now to FIG. 2, the flexible mount 50 is securely connected to the head of the guitar 6 by any conventional means, such as, by way of non-limiting example, fasteners adhesives or the like. The flexible mount 50 is formed, at least in part, of a flexible or pliable material adapted to receive the magnet therein in a compression fit. Although the flexible mount 50 appears in FIG. 2 to be of a uniform construction, it will be appreciated that it may be formed of more than one element such that it may include an outer casing to facilitate connection to the musical instrument and an interior formed of a pliable or flexible material adapted to hold the activating magnet 40 therein as will be more fully described below.

The flexible mount 50 includes a bore 52 therein defined by an outer wall 54 having a diameter. The material surrounding the flexible mount 50 is, in particular, formed of the pliable or flexible material such that any magnet located therein is permitted a degree of movement under vibration due to the flexibility of the material. In particular, the diameter of the bore 52 may be selected to be smaller than an outer surface 42 of the activating magnet 40 so as to form an interference fit therebetween. By way of non-limiting example, the flexible mount 50 and in particular the portion surrounding the bore 52 may be selected from foams, foam rubbers, rubbers silicone or the like. The bore 52 may optionally include a cover or other securing means to ensure the activating magnet 40 is retained therein.

Although the above description includes the apparatus 10 in the head 6 of a guitar, it will be appreciated that it may also be located in any other location in the guitar as well as in any other instrument whereby the sound of the instrument is produced by vibration of a portion of the body thereof. It will also be appreciated that although a single ferromagnetic core and magnet are illustrated and described above, that multiple ferromagnetic cores and multiple magnets (in matching or different quantities) may also be utilized. It will be appreciated that utilizing multiples of such ferromagnetic cores and magnets will permit a degree of personalization of the sound output of the apparatus according to known amplification techniques, including without limitation varying the gauge, material and windings of the electrical windings.

Additionally, although the ferromagnetic core and windings are illustrated and described above as fixedly connected to the instrument with a flexibly coupled magnet, it will be appreciated that the relative positions of the magnet and ferromagnetic core may be swapped. In such configurations, the magnet may be secured within a bore of the instrument, by way of non-limiting example with a flexibly coupled ferromagnetic core. Such configurations may permit the flexible mount to be coupled and decoupled to the instrument with the wire 24 extending away therefrom. It will be appreciated that such configuration would advantageously permit the replacement of the electrical winding and ferromagnetic core so as to adjust the sound characteristics produced thereby.

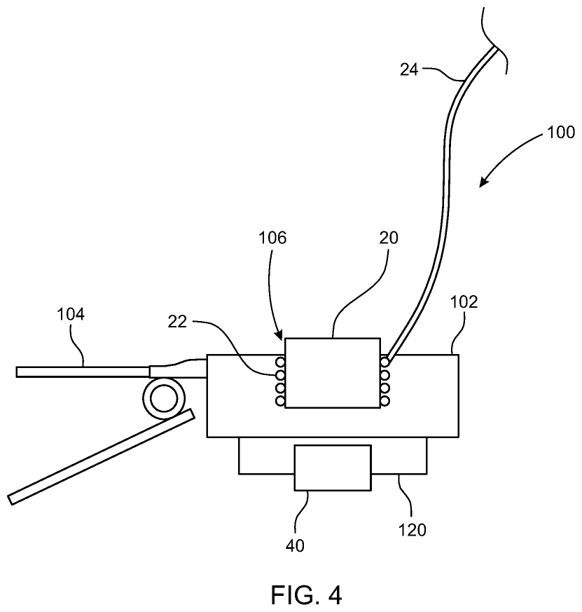

Turning now to FIG. 4, a further embodiment is illustrated generally at 100 comprising a body 102 connectable to an instrument and having a flexible mount 120 connected thereto. The body 102 may include a clamp 104 or other coupling means as are commonly known for securing the body 102 to an instrument. The body 102 includes a bore 106 therein adapted to securely receive one of the ferromagnetic core 20 or a activating magnet 40 therein. The body further includes a flexible mount 120 secured thereto as set out above which flexible mounts the magnet (as illustrated in FIG. 4) or the ferromagnetic core therein. It will be appreciated that the apparatus as illustrated in FIG. 4 permits the application to an existing musical instrument without modification of the instrument.

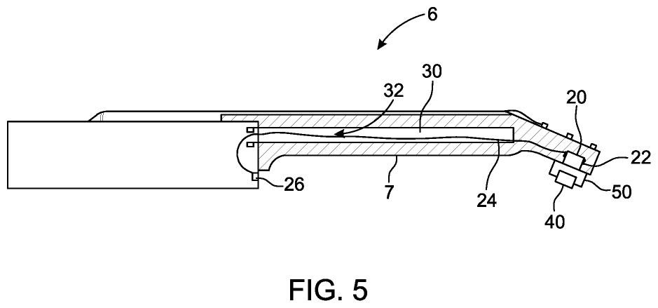

Turning now to FIG. 5, according to a further embodiment, the guitar 8 may include a truss rod 30 extending through the neck 7 as is commonly known. The truss rod 30 may be adapted to be substantially hollow having a central bore 32 extending the length thereof. As illustrated in FIG. 5, the wire 24 may be passed through the central bore 32 of the truss rod 30 so as to terminate at a plug 26 in the body of the guitar as is commonly known.

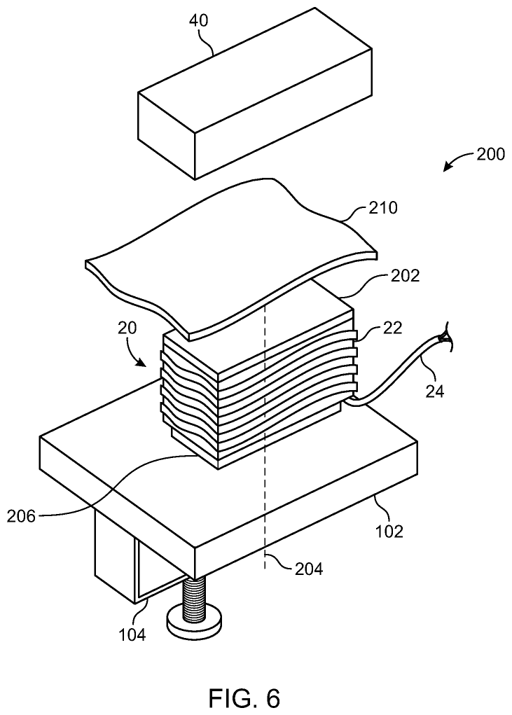

Turning now to FIG. 6, according to a further embodiment, the pickup 200 may comprise a body 102 having a clamp 104 as set out above. The ferromagnetic core 20 may be formed of an iron core 202 surrounded by the electrical winding 22. As illustrated in FIG. 6, the iron core 202 may have any suitable shape such as rectangular, circular or otherwise as are known wherein the electrical windings 22 define an axis 204 extending therethrough. A permanent magnet 206 may be secured to the iron core at an open end of the electrical winding 22 perpendicularly to the axis 204 and the entire ferromagnetic core 20 may then be secured to the body 102. In operation, a flexible mount, in the form of a sheet of pliable material 210 may be located over the ferromagnetic core 20 and the activation magnet 40 located thereover so as to magnetically clamp the sheet 210 therebetween. The sheet 210 may be formed of any suitable pliable material, such as, by way of non-limiting example, foams, foam rubbers, rubbers silicone or the like. In practice it has been found that a silicone sheet having a thickness of approximately 30 thousandths of an inch has been useful although it will be appreciated that other materials and thicknesses may be useful as well depending upon the instrument, strengths of the magnets and number and dimensions of the electrical windings.

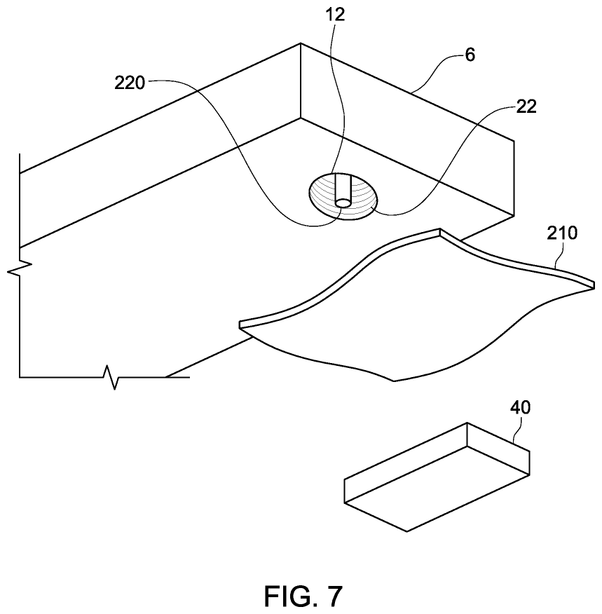

It will also be appreciated that the use of a sheet to form the flexible mount may also be utilized in permanently installed pickup. As illustrated in FIG. 7, the ferromagnetic core may comprise a magnetic pin 220 located with the electrical winding 22 within a bore 12 in the instrument. In use, the flexible sheet 210 may be located thereover and the activation magnet 40 magnetically coupled to the pin 220 so as to clamp the sheet therebetween.

While specific embodiments have been described and illustrated, such embodiments should be considered illustrative only and not as limiting the disclosure as construed in accordance with the accompanying claims.

What is claimed is:

1. A pickup for a musical instrument comprising:
a ferromagnetic core having an electrical winding wound therearound, the electrical winding having an output wire operable to output a signal for receipt by an amplifier representing sound vibrations produced by the musical instrument;
an activation magnet; and
a flexible mount,
wherein one of the ferromagnetic core and the activation magnet are rigidly secured to the musical instrument and wherein the flexible mount is located the ferromagnetic core and activation magnet so as to permit a degree of movement by the other of the ferromagnetic core and activation magnet relative to the musical instrument under vibration thereof.

2. The pickup of claim 1 wherein one of the ferromagnetic core and the activation magnet is secured within a cavity in the musical instrument.

3. The pickup of claim 1 wherein the flexible mount is permanently secured to the musical instrument.

4. The pickup of claim 1 wherein the ferromagnetic core is rigidly connected to the musical instrument and wherein the activation magnet is located within the flexible mount.

5. The pickup of claim 1 wherein the activation magnet is rigidly connected to the musical instrument and wherein the ferromagnetic core is located within the flexible mount.

6. The pickup of claim 1 wherein the flexible mount comprise a sheet of pliable material magnetically clamped between the ferromagnetic core and the activation magnet.

7. The pickup of claim 6 wherein the sheet of pliable material is selected from the group consisting of silicone, foam and rubber.

8. The pickup of claim 1 wherein the ferromagnetic core includes a permanent magnet attached thereto.

9. The pickup of claim 8 wherein the ferromagnetic core comprises an iron core having the electrical winding therearound defining an axis therethrough.

10. The pickup of claim 9 further comprising a permenant magnet secured to the iron core perpendicularly to the axis.

11. The pickup of claim 10 wherein the iron core has a substantially rectangular cross section.

12. The pickup of claim 1 further comprising a body selectably coupleable to the musical instrument having the ferromagnetic core connected thereto.

13. The pickup of claim 12 wherein the flexible mount includes a connector operable to selectably couple and decouple the flexible mount to the musical instrument.

14. The pickup of claim 13 wherein the connector comprises a clamp.

15. The pickup of claim 1 wherein the flexible mount includes a pocket adapted to receive the activation magnet.

16. The pickup of claim 15 wherein the pocket is sized to compressibly receive one of the ferromagnetic core and the activation magnet therein.

17. The pickup of claim 1 wherein the output wire extends down a neck of the guitar to a plug in a body of the guitar.

18. The pickup of claim 15 wherein the output wire is located within a truss rod extending through the neck.

19. A method for amplifying a musical instrument comprising:
providing a ferromagnetic core having an electrical winding wound therearound, the electrical winding having an output wire operable to output a signal for receipt by an amplifier representing sound vibrations produced by the musical instrument;
locating a flexible mount between the ferromagnetic core and an activation magnet;
rigidly securing one of the ferromagnetic core and the activation magnet to the musical instrument; and
magnetically coupling the ferromagnetic core and the activation magnet together with the flexible mount therebetween as to have a degree of movement relative to each other under vibration from the musical instrument.

20. A kit for amplifying a musical instrument comprising:
a ferromagnetic core having an electrical winding wound therearound, the electrical winding having an output wire operable to output a signal for receipt by an amplifier representing sound vibrations produced by the musical instrument;
an activation magnet; and
a flexible mount securable between the ferromagnetic core and the activation magnet,
wherein one of the ferromagnetic core and the activation magnet are rigidly securable to the musical instrument and wherein the other of the ferromagnetic core and activation magnet is magnetically secured thereto with the flexible mount therebetween so as to have a degree of movement relative to the musical instrument under vibration thereof.
